(19) United States
(12) Patent Application Publication
(10) Pub. No.: US 2024/0383813 A1
(43) Pub. Date: Nov. 21, 2024

(54) A METHOD BONDING SEALING ELEMENTS TO SUBSTRATES USING A CEMENTITIOUS ADHESIVE

(71) Applicant: SIKA TECHNOLOGY AG, Baar (CH)

(72) Inventors: Flaviane ALVES DOS SANTOS, Hoboken, NJ (US); Mohamed CADER, Cranford, NJ (US); Andrew NEY, Jersey City, NJ (US)

(73) Assignee: SIKA TECHNOLOGY AG, Baar (CH)

(21) Appl. No.: 18/688,415

(22) PCT Filed: Sep. 6, 2022
(86) PCT No.: PCT/EP2022/074760

§ 371 Date: Mar. 1, 2024

(30) Foreign Application Priority Data
Sep. 6, 2021 (EP) 21194953.2

(51) Int. Cl. C04B 28/14; C04B 28/04; C04B 103/00; C04B 111/00; C04B 111/27; C08J 5/12

(52) U.S. Cl. CPC C04B 28/14; C04B 28/04; C08J 5/12; C04B 2103/0057; C04B 2111/00637; C04B 2111/27; C08J 2323/08

(57) ABSTRACT

A method for bonding of a sealing element to a substrate using a cementitious adhesive composition having at least one synthetic organic polymer and at least one hydraulic binder. The invention also relates to a sealed structure and to use of a wet cementitious adhesive composition for bonding of a sealing element to a surface of a substrate.

### TECHNICAL FIELD

The invention relates to bonding of sealing elements to substrates using cementitious adhesives. In particular, the invention relates to waterproofing of above and below ground structures using post-applied sealing elements, such as waterproofing and roofing membranes, to provide waterproofed structures.

### BACKGROUND ART

In the field of construction, polymeric sealing elements that are often referred to as membranes, panels, sheets, or liners are used to protect underground and above ground constructions, such as base slabs, walls, floors, basements, tunnels, wet rooms, building facades, flat and low-sloped roofs, landfills, water-retaining structures, ponds, and dikes against penetration of water, moisture, harmful gases, and volatile organic compounds. Waterproofing membranes are applied, for example, to prevent ingress of water through cracks that develop in the concrete structure due to building settlement, load deflection or concrete shrinkage. They are also used in heavy loaded commercial and residential wet rooms, shower rooms or therapy rooms in hospitals, and on balconies, terraces and in swimming pools to protect the structures against penetration of water.

Roofing membranes are used for sealing of flat and low-sloped roof structures to prevent leaks and to move take water off the roof. Gas barrier membranes are used for restricting the ingress of harmful gases, such as radon, methane, and carbon dioxide, into buildings from landfill and naturally occurring sources. These types of membranes are typically used in ground floors above and below concrete slabs that are not subjected to hydrostatic pressure. Vapor barriers and retarders are used to control the movement of water through a building structure by vapor diffusion. Vapor retarding membranes are provided with different water vapor permeance properties or permeability and they are commonly provided as coatings or multilayer composites composed of several thin films or as structural vapor retarders. Geomembranes are used in contact with soil or rock to act as a barrier to passage of water and water-borne contaminants.

Generally, the membranes can be “post-applied” to an existing concrete structure or “pre-applied” before the structure to be sealed against penetration of water, moisture, and harmful gases has been formed. Post-applied membranes can be adhered to a surface of the substrate, for example, by using adhesives or mechanical fastening means and/or by using sealing tapes. The adhesive can be applied to a surface of the membrane and/or to the substrate during the installation of the membrane. Alternatively, self-adhering membranes, also known as “peel and stick membranes”, having a factory applied layer of a pressure sensitive adhesive can be used. Pre-applied membranes are placed on a surface of the underlying concrete structure or formwork and fresh concrete is then casted against a surface of the membrane thereby fully and permanently bonding the membrane to the surface of the hardening concrete body.

Commonly used materials for the membranes include plastics, in particular thermoplastics, such as plasticized polyvinylchloride (p-PVC), thermoplastic olefins (TPE-O, TPO), and rubbers, such as ethylene-propylene diene monomer (EPDM). Polymeric materials having a low surface energy, such as polyolefin-based materials, are notoriously difficult to bond with adhesives that are commonly used in the field of construction industry, such as epoxy adhesives and polyurethane adhesives. Furthermore, commonly used adhesives cannot be used for bonding of membranes to surfaces of green concrete bodies, i.e., to surfaces of concrete substrates that have not yet been fully hardened. It has been found out that even small amount of residual moisture on the surface of the concrete effectively prevents the use of polyurethane-based adhesives for bonding of membranes to concrete substrates. Providing an adhesive composition, which allows bonding of membranes to green concrete substrates would be highly desirable, since it would enable significant shortening of installation times in post-applied waterproofing applications. Typically, a membrane can be post-applied only to fully cured concrete substrates, which have been allowed to harden for at least 28 days.

There is thus a need for a novel method, which enables bonding of polymeric sealing elements to substrates, particularly to concrete substrates, which have not been fully cured and thus have a relatively high surface moisture content.

### SUMMARY OF THE INVENTION

The objective of the present invention is to provide a method, which enables bonding of polymeric sealing elements to wet or damp surfaces of substrates.

Another objective of the invention is to provide a method that enables waterproofing of green concrete bodies using post-applied waterproofing membranes.

It was surprisingly found that a cementitious adhesive comprising at least one synthetic organic polymer and at least one hydraulic binder can be used for bonding of polymeric sealing elements, such as waterproofing membranes, to wet or damp surfaces of substrates, particularly to surfaces of green concrete bodies.

The subject of the present invention is a method for bonding a sealing element as defined in claim 1.

One of the advantages of the method of the present invention is that it enables shortening of the installation times of post-applied sealing elements, such as waterproofing, roofing, gas barrier, volatile organic compound (VOC) barrier, and façade membranes. Furthermore, the adhesive composition can be provided as a one-component composition, which also simplifies the installation process, since the end user at the construction site has to determine only the correct amount of water to be the added to the one-component composition to provide a ready-to-use wet adhesive composition. This not only saves time at the construction site but also reduces the risk that proportions of constituents would be incorrectly measured.

Other subjects of the present invention are presented in other independent claims. Preferred aspects of the invention are presented in the dependent claims.

### BRIEF DESCRIPTION OF THE DRAWINGS

FIG. 1 shows a cross-section of a sealing element (1) comprising a contact layer (2), which is form of a filled polymeric layer.

FIG. 2. shows a cross-section of a sealing element (1) comprising a contact layer (2), which is in form of a filled polymeric layer, wherein the upper and lower major surfaces of the filled polymeric layer contain a surface structure (3, 4).

FIG. 3 shows a cross-section of a sealing element (1) comprising a contact layer (2) covering an upper major surface of a waterproofing layer (5), wherein the contact layer (2) is in form of a filled polymeric layer.

FIG. 4 shows a cross-section of a sealing element (1) comprising a contact layer (2) covering an upper major surface of a waterproofing layer (5), wherein the contact layer (2) is in form of a filled polymeric layer and the upper major surface of the filled polymeric layer contains a surface structure (3).

FIG. 5 shows a cross-section of a sealing element (1) comprising a contact layer (2) covering an upper major surface of a waterproofing layer (5), wherein the contact layer (2) is in form of a layer of fiber material.

FIG. 6 shows a cross-section of a sealed structure comprising a sealing element (1) and a substrate (6), wherein the sealing element (1) comprises a contact layer (2) and a waterproofing layer (5), wherein the contact layer (2) is in form of a filled polymeric layer and wherein the sealing element (1) is adhered to a surface of the substrate (6) via an adhesive layer (7), which forms an interlayer between the contact layer (2) and the surface of the substrate (6).

### DETAILED DESCRIPTION OF THE INVENTION

The subject of the present invention is a method for bonding a sealing element (1) to a substrate (6), the method comprising steps of:
I) providing an adhesive composition and mixing the composition with water to obtain a wet adhesive composition,
II) applying the wet adhesive composition to a surface of the substrate (6) or to a surface of the sealing element (1) to form a wet adhesive layer,
III) joining the sealing element (1) with the substrate (6) such that the wet adhesive layer forms an interlayer between the sealing element (1) and the substrate (6) such that at least a portion of the opposing surfaces of the sealing element (1) and the substrate (6) are directly connected to each other via the interlayer, and
IV) letting the wet adhesive layer to harden to effect adhesive bonding between the sealing element (1) and the substrate (6), wherein
the adhesive composition comprises:
a) 2.5-50 wt.-%, preferably 5-40 wt.-%, of at least one synthetic organic polymer SP and
b) 25-95 wt.-%, preferably 35-90 wt.-%, of at least one hydraulic binder H, said proportions being based on the total weight of the adhesive composition.

The term “polymer” refers to a collective of chemically uniform macromolecules produced by a polyreaction (polymerization, polyaddition, polycondensation) where the macromolecules differ with respect to their degree of polymerization, molecular weight, and chain length. The term also comprises derivatives of said collective of macromolecules resulting from polyreactions, that is, compounds which are obtained by reactions such as, for example, additions or substitutions, of functional groups in predetermined macromolecules and which may be chemically uniform or chemically non-uniform.

Term “polyolefin” refers in the present disclosure to homopolymers and copolymers obtained by polymerization of olefins optionally with other types of comonomers.

The term “α-olefin” designates an alkene having the molecular formula CₓH₂ₓ (x corresponds to the number of carbon atoms), which features a carbon-carbon double bond at the first carbon atom (α-carbon). Examples of α-olefins include ethylene, propylene, 1-butene, 2-methyl-1-propene (isobutylene), 1-pentene, 1-hexene, 1-heptene and 1-octene. For example, neither 1,3-butadiene, nor 2-butene, nor styrene are referred as “α-olefins” according to the present document.

The term “copolymer” refers in the present disclosure to a polymer derived from more than one species of monomer (“structural unit”). The polymerization of monomers into copolymers is called copolymerization. Copolymers obtained by copolymerization of two monomer species are known as bipolymers and those obtained from three and four monomer species are called terpolymers and quaterpolymers, respectively.

The term “rubber” refers in the present disclosure to a polymer or a polymer blend, which is capable of recovering from large deformations, and which can be, or already is, modified to a state in which it is essentially insoluble (but can swell) in a boiling solvent, in particular xylene. Typical rubbers are capable of being elongated or deformed to at least 200% of their original dimension under an externally applied force, and will substantially resume the original dimensions, sustaining only small permanent set (typically no more than about 20%), after the external force is released. As used herein, the term “rubber” may be used interchangeably with the term “elastomer.”

The term “molecular weight” designates the molar mass (g/mol) of a molecule or a part of a molecule, also referred to as “moiety”. The term “average molecular weight” refers to number or weight average molecular weight (Mₙ, M_{w}) of an oligomeric or polymeric mixture of molecules or moieties. The molecular weight can be determined by conventional methods, preferably by gel permeation-chromatography (GPC) using polystyrene as standard, styrene-divinylbenzene gel with porosity of 100 Angstrom, 1000 Angstrom and 10000 Angstrom as the column, and depending on the molecule, tetrahydrofurane as a solvent at 35° C. or 1,2,4-trichlorobenzene as a solvent at 160° C.

The term “melting temperature” designates a temperature at which a material undergoes transition from the solid to the liquid state. The melting temperature (Tₘ) is preferably determined by differential scanning calorimetry (DSC) according to ISO 11357-3:2018 standard using a heating rate of 2° C./min. The measurements can be performed with a Mettler Toledo DSC 3+ device and the Tₘ values can be determined from the measured DSC-curve with the help of the DSC-software. In case the measured DSC-curve shows several peak temperatures, the first peak temperature coming from the lower temperature side in the thermogram is taken as the melting temperature (Tₘ).

The term “glass transition temperature” (T_{g}) designates the temperature above which temperature a polymer component becomes soft and pliable, and below which it becomes hard and glassy. The glass transition temperature is preferably determined by dynamical mechanical analysis (DMA) as the peak of the measured loss modulus (G″) curve using an applied frequency of 1 Hz and a strain level of 0.1%.

The “amount or content of at least one component X” in a composition, for example “the amount of the at least one ethylene vinyl acetate copolymer” refers to the sum of the individual amounts of all ethylene vinyl acetate copolymers contained in the composition. Furthermore, in case the composition comprises 20 wt.-% of at least one ethylene vinyl acetate copolymer, the sum of the amounts of all ethylene vinyl acetate copolymer contained in the composition equals 20 wt.-%.

The term “normal room temperature” refers to the temperature of 23° C.

The adhesive composition that is mixed with water in step I) of the method can be a one-component composition or a multiple-component composition. In the present document, the term “one-component” refers to a composition in which all constituents of the composition are stored in a mixture in the same container or compartment whereas a “multiple-component” refers to a composition in which the constituents of the composition are present in multiple different components that are stored in separate containers or compartments.

According to one or more preferred embodiments, the adhesive composition is a one-component adhesive composition.

According to one or more embodiments, the adhesive composition is in form of a powder, preferably a free-flowing powder. The term “powder” refers in the present disclosure a material that is in form of solid particles. A “free-flowing powder” refers to a powder, in which the particles do not stick together to form aggregates.

The wet adhesive composition obtained by mixing the adhesive composition with water can be applied either to a surface of the substrate or to a surface of the sealing element to form a wet adhesive layer. The substrate to which the sealing element is bonded may be comprised of variety of materials depending on the installation site. The substrate may, for example, be a concrete, fiber concrete, polymer, metal, wood, or a plywood substrate, or it may include a base slab, a side wall, a tunnel structure, a roof deck, an insulation board or cover board or an existing waterproofing or roofing membrane.

According to one or more embodiments, the substrate is selected from the group consisting of concrete body, an insulation board, or a cover board.

Suitable insulation boards for use as the substrate include, for example, foam panels having a closed or semi-closed cell structure, such as molded expanded polystyrene (EPS) foam panels, extruded expanded polystyrene (XPS) foam panels, polyurethane foam panels (PUR), and polyisocyanurate (PIR) foam panels. Suitable cover boards include, for example, gypsum boards, fiber-reinforce gypsum boards, wood fiber boards, cementitious boards, high-density (compressed) polyisocyanurate boards, perlite boards, asphaltic boards, mineral fiber boards, and plywood or oriented strand boards.

The surface of the substrate can be a primed surface or non-primed surface. The expression “primed surface” is understood to mean that the surface layer of the substrate is a primer layer, i.e. composed of a primer composition. Primers are commonly used to enhance adhesion of adhesives, coatings, and sealants to substrates. According to one or more embodiments the surface of the substrate is a non-primed surface.

According to one or more embodiments, the substrate is a concrete body, preferably a green concrete body. The term “green concrete” refers in the present document to a concrete mass that has set but has not been fully cured.

The term “green concrete body” refers to a concrete mass that has been allowed to cure after casting for less than 28 days, preferably less than 24 days, more preferably less than 16 days, still more preferably less than 8 days, even more preferably less than 5 days, most preferably less than 3 days, particularly less than 2 days, such as less than 24 hours.

According to one or more preferred embodiments, the substrate has a surface moisture content determined according to ASTM F2659 standard of at least 2 wt.-% of water, preferably at least 3 wt.-% of water, more preferably at least 4 wt.-% of water, even more preferably at least 5 wt.-% of water, particularly in the range of 2-16 wt.-% of water, preferably 2-12 wt.-% of water, more preferably 3-10 wt.-% of water, even more preferably 4-8 wt.-% of water.

The surface moisture content according to ASTM F2659 standard of a substrate is preferably measured using a Tramex® CME4 screed moisture measuring instrument as average of three measurements.

According to one or more embodiments, the adhesive composition comprises:
a) 5-35 wt.-%, preferably 7.5-30 wt.-%, more preferably 10-30 wt.-%, even more preferably 10-25 wt.-%, most preferably 10-20 wt.-%, of the at least one synthetic organic polymer SP and
b) 40-90 wt.-%, preferably 50-90 wt.-%, more preferably 60-90 wt.-%, even more preferably 65-90 wt.-%, most preferably 70-90 wt.-%, of the at least one hydraulic binder H, all proportions being based on the total weight of the adhesive composition.

Suitable polymers for use as the at least one synthetic organic polymer SP include, for example, copolymers obtained from free radical polymerization of monomers selected from the group consisting of ethylene, propylene butylene, isoprene, butadiene, styrene, acrylonitrile, (meth)acrylic acid, (meth)acrylate, vinyl ester, and vinyl chloride and polyurethane polymers. The term “polyurethane polymer” refers in the present disclosure to polymers prepared by so called diisocyanate polyaddition process, including those polymers which are almost or completely free of urethane groups. Examples of polyurethane polymers are polyether polyurethanes, polyester polyurethanes, polyether polyureas, polyureas, polyester polyureas, polyisocyanurates, and polycarbodiimides. The term (meth)acrylate refers to acrylate and methacrylate.

According to one or more embodiments, the at least one organic polymer SP is a copolymer, such as a random copolymer or a block copolymer, preferably obtained by polymerization of two or more different types of monomers, preferably selected from the group consisting of copolymers of vinyl acetate and ethylene, copolymers of vinyl acetate, ethylene, and (meth)acrylate, copolymers of vinyl acetate, ethylene, and vinyl ester, copolymers of vinyl chloride, ethylene, and vinyl laureate, copolymers of vinyl acetate and vinyl versatate, copolymers of (meth)acrylate and styrene, copolymers of (meth)acrylate, styrene, and butadiene, copolymers of (meth)acrylate and acrylonitrile, copolymers of styrene and butadiene, and copolymers of (meth)acrylic acid and styrene.

According to one or more preferred embodiments, the at least one synthetic organic polymer SP is in form of a re-dispersible polymer powder. The term “re-dispersible polymer powder” refers to a polymer containing powder, which when mixed with water forms a stable dispersion. A re-dispersible polymer powder is typically not composed of the polymer but comprises a mixture of the polymer with colloidal stabilizers, antiblocking agents (emulsifiers), and carrier materials. Re-dispersible polymer powders can be produced, for example, by spray-drying of water-based polymer dispersions, for example, by using the methods as disclosed in patent application EP 1042391 A1.

Suitable re-dispersible polymer powders are commercially available, for example from Wacker Chemie under the trade name of Vinnapas®, such as Vinnapas® 8000 series, from Synthomer under the trade names of Axilat®, such as Axilat® HP 8000 series, Axilat® UP series, Axilat® PSB 150, and Axilat® PAV series, and from Celanese und the trade name of Elotex®, such as Elotex® FX2320.

The adhesive composition further comprises as the second compulsory constituent at least one hydraulic binder H.

The term “hydraulic binder” refers the present document an inorganic material or blend, which forms a paste when mixed with water, and which sets and hardens by a series of hydration reactions resulting in formation of solid mineral hydrates or hydrate phases, which are not soluble in water or have a very low water-solubility. Hydraulic binders, such as Portland cement, can harden and retain their strength even when exposed to water, for example underwater or under high humidity conditions. In contrast, the term “non-hydraulic binder” refers to substances, which harden by reaction with carbon dioxide and which, therefore, do not harden in wet conditions or under water.

Preferred hydraulic binders for use as the at least one hydraulic binder H include Portland cement, aluminate cement, and calcium sulfoaluminate cement.

The term “Portland cement” as used herein is intended to include those cements normally understood to be “Portland cements”, particularly those described in European Standard EN-197. Portland cement consists mainly of tri-calcium silicate (alite) (C₃S) and dicalcium silicate (belite) (C₂S). Preferred Portland cements include the types CEM I, CEM II, CEM Ill, CEM IV, and CEM V compositions of the European standard EN 197-1:2018-11. However, all other Portland cements that are produced according to another standard, for example, according to ASTM standard, British (BSI) standard, Indian standard, or Chinese standard are also suitable.

The term “aluminate cement” as used herein is intended to include those cementitious materials that contain as the main constituent (phase) hydraulic calcium aluminates, preferably mono calcium aluminate CA (CaO·Al2O3). Depending on the type of the aluminate cement, other calcium aluminates, such as CA₂, C₃A, and C₁₂A₇, may also be present. Preferred aluminate cements include also other constituents, such as belite (C₂S), alite (C₃S), ferrites (C₂F, C₂AF, C₄AF), and ternesite (C₅S₂\dot{S}). Some aluminate cements also contain calcium carbonate.

Most preferred aluminate cements for use as the at least one hydraulic binder H include calcium aluminate cements (CAC), which fulfill the requirements of the norm EN 4647 (“Calcium Aluminate Cement”). Suitable calcium aluminate cements are commercially available, for example, from Imerys Aluminates and Royal White Cement.

The term “calcium sulfoaluminate cement (CSA)” is intended to include those cementitious materials that contain as the main constituent (phase) C₄(A3-xFx)3\dot{S} (4CaO·3-x Al2O3·x Fe2O3·CaSO4), wherein x has a value of 0, 1, 2, or 3. Typically, calcium sulfoaluminate cements also include other constituents, such as aluminates (CA, C₃A, C₁₂A₇), belite (C₂S), ferrites (C₂F, C₂AF, C₄AF), ternesite (C₅S₂\dot{S}), and calcium sulfate. Preferred calcium sulfoaluminate cements for use as the at least one hydraulic binder H contain 20-80 wt.-% of ye'elimite (C4A3\dot{S}), 0-10 wt.-% of calcium aluminate (CA), 0-70 wt.-% of belite (C₂S), 0-35 wt.-% of ferrite, preferably tetracalcium aluminoferrite (C₄AF), and 0-20 wt.-% of ternesite (C₅S₂\dot{S}), based on the total weight of the calcium sulfoaluminate cement. Suitable calcium aluminate cements are commercially available, for example, from Heidelberg Cement AG, Vicat SA, and Caltra B.V.

According to one or more embodiments, the at least one hydraulic binder H is selected from the group consisting of Portland cement, calcium aluminate cement (CAC), and calcium sulfoaluminate cement (CSA), preferably from the group consisting of Portland cement and calcium aluminate cement (CAC).

According to one or more embodiments, the weight ratio of the amount of water to the amount of the at least one hydraulic binder H in the wet adhesive composition obtained from the mixing step I) is in the range of 0.1:1 to 2:1, preferably 0.2:1 to 1:1, more preferably 0.3:1 to 0.9:1, even more preferably 0.3:1 to 0.8:1.

The water can be any available water, such as distilled water, purified water, tap water, mineral water, and well water. The use of wastewater is also possible in cases where the composition of the wastewater is known and wherein none of the contaminants contained in the wastewater can influence the functionality of the constituents of the adhesive composition. The use of salt water is possible but not particularly preferred due to the high content of chlorides and the associated risk of corrosion of metal parts.

Any static or dynamic mixing device or method can be used for the mixing of the adhesive composition with water, such as a dissolver disc, blade, or other similar apparatus, as long as a macroscopically homogeneously mixed mixture can be obtained.

The wet adhesive composition obtained from the mixing step I) has a pot-life at normal room temperature of 15-240 min, such as 45-180 min, during which the application of the adhesive composition must be performed. The pot-life depends mainly on the amount and type of the at least one hydraulic binder H. After a time period corresponding to the pot life, the hardening reactions of the hydraulic binder H makes a subsequent application difficult or even impossible.

Preferably, time between the steps II) and III) is relatively short, i.e., it is not preferred that the wet adhesive layer is dried to a significant extent before joining of the sealing element with the substrate. According to one or more embodiments, the interlayer formed in step IIII) by joining of the sealing element with the substrate contains at least 75 wt.-%, preferably at least 85 wt.-%, more preferably at least 95 wt.-%, of the amount of water contained in the wet adhesive composition obtained from step I).

The sealing element can be any type of sheet, panel, strip, or layer of material that can be used for sealing of the surface of the substrate against penetration of water, moisture, or harmful gases. According to one or more embodiments, the sealing element is selected from the group consisting of a waterproofing membrane, roofing membrane, gas barrier membrane, volatile organic compound (VOC) barrier membrane, vapor barrier membrane, vapor retarder membrane, façade membrane, and a geomembrane.

Preferably, the sealing element comprises an outer major surface, which is operative to form a bond with the wet adhesive composition after hardening.

According to one or more embodiments, the sealing element comprises a contact a contact layer, wherein in step III) of the method, the sealing element is joined with the substrate such that the wet adhesive layer forms an interlayer between the contact layer and substrate.

The type of the contact layer is not particularly restricted. Any type of layer of material that is operative to form a bond with the wet adhesive composition after hardening is in principle suitable for use as the contact layer of the sealing element.

According to one or more embodiments, the contact layer is selected from a layer of fiber material, a filled polymeric layer, a bitumen-based layer, and a layer of pressure sensitive adhesive.

According to one or more embodiments, the contact layer comprises or is composed of a layer of fiber material.

The term “fiber material” designates in the present document materials composed of fibers comprising or consisting of, for example, organic, inorganic, or synthetic organic materials. Examples of organic fibers include, for example, cellulose fibers, cotton fibers, and protein fibers. Particularly suitable synthetic organic materials include, for example, polyester, homopolymers and copolymers of ethylene and/or propylene, viscose, nylon, and polyamides. Fiber materials composed of inorganic fibers are also suitable, particular, those composed of metal fibers or mineral fibers, such as glass fibers, aramid fibers, wollastonite fibers, and carbon fibers. Inorganic fibers, which have been surface treated, for example, with silanes, may also be suitable. The fiber material can comprise short fibers, long fibers, spun fibers (yarns), or filaments. The fibers can be aligned or drawn fibers. It may also be advantageous that the fiber material is composed of different types of fibers, both in terms of geometry and composition.

Preferably, the layer of fiber material is selected from the group consisting of non-woven fabrics, woven fabrics, and laid scrims.

The term “non-woven fabric” designates in the present document materials composed of fibers, which are bonded together by using chemical, mechanical, or thermal bonding means, and which are neither woven nor knitted. Non-woven fabrics can be produced, for example, by using a carding or needle punching process, in which the fibers are mechanically entangled to obtain the nonwoven fabric. In chemical bonding, chemical binders such as adhesive materials are used to hold the fibers together in a non-woven fabric.

The term “laid scrim” refers in the present disclosure web-like non-woven products composed of at least two sets of parallel yarns (also designated as weft and warp yarns), which lay on top of each other and are chemically bonded to each other. The yarns of a non-woven scrim are typically arranged with an angle of 60-120°, such as 90±5°, towards each other thereby forming interstices, wherein the interstices occupy more than 60% of the entire surface area of the laid scrim. Typical materials for laid scrims include metal fibers, inorganic fibers, in particular glass fibers, and synthetic organic fibers, in particular polyester, polypropylene, polyethylene, and polyethylene terephthalate (PET).

According to one or more embodiments, the layer of fiber material is a non-woven fabric, preferably having a mass per unit weight of not more than 350 g/m², preferably not more than 300 g/m². According one or more embodiments, the layer of fiber material is a non-woven fabric having a mass per unit weight of 15-300 g/m², preferably 20-250 g/m², more preferably 25-200 g/m², even more preferably 30-150 g/m².

Preferably, the non-woven fabric comprises synthetic organic and/or inorganic fibers. Particularly suitable synthetic organic fibers for the non-woven fabric include, for example, polyester fibers, polypropylene fibers, polyethylene fibers, nylon fibers, and polyamide fibers. Particularly suitable inorganic fibers for the non-woven fabric include, for example, glass fibers, aramid fibers, wollastonite fibers, and carbon fibers.

According to one or more embodiments, the non-woven fabric has as the main fiber component synthetic organic fibers, preferably selected from the group consisting of polyester fibers, polypropylene fibers, polyethylene fibers, nylon fibers, and polyamide fibers. According to one or more further embodiments, the non-woven fabric has as the main fiber component inorganic fibers, preferably selected from the group consisting of glass fibers, aramid fibers, wollastonite fibers, and carbon fibers, more preferably glass fibers.

According to one or more further embodiments, the contact layer comprises or is composed of a filled polymeric layer comprising:
20-90 wt.-%, preferably 25-85 wt.-%, more preferably 30-80 wt.-%, even more preferably 35-75 wt.-%, still more preferably 40-70 wt.-%, of at least one polymer P1,
5-75 wt.-%, preferably 10-70 wt.-%, more preferably 15-65 wt.-%, even more preferably 20-60 wt.-%, still more preferably 25-55 wt.-%, of at least one inorganic filler F, all proportions being based on the total weight of the filled polymeric layer.

Preferably, the at least one polymer P1 comprises at least one ethylene vinyl acetate copolymer P11. Preferably the at least one ethylene vinyl acetate copolymer P11 has a content of a structural unit derived from vinyl acetate of at least 5 wt.-%, more preferably at least 15 wt.-%, even more preferably at least 25 wt.-%, still more preferably at least 35 wt.-%, most preferably at least 45 wt.-%, based on the weight of the copolymer.

According to one or more embodiments, the at least one ethylene vinyl acetate copolymer P11 has a content of a structural unit derived from vinyl acetate of 5-95 wt.-%, preferably 15-90 wt.-%, more preferably 25-90 wt.-%, even more preferably 35-90 wt.-%, still more preferably 45-90 wt.-%, based on the weight of the copolymer. According to one or more preferred embodiments, the at least one ethylene vinyl acetate copolymer P11 has a content of a structural unit derived from vinyl acetate of 35-95 wt.-%, preferably 45-95 wt.-%, more preferably 55-90 wt.-%, even more preferably 65-90 wt.-%, still more preferably 70-90 wt.-%, based on the weight of the copolymer.

Ethylene vinyl acetate copolymers having the content of a structural unit derived from vinyl acetate in the above cited ranges are especially suitable for use in the filled polymeric layer since they have been found out to provide the contact layer with an increased the strength of bonding to the wet adhesive composition after hardening.

Particularly suitable ethylene vinyl acetate copolymers include ethylene vinyl acetate bipolymers and terpolymers, such as ethylene vinyl acetate carbon monoxide terpolymers.

Suitable ethylene vinyl acetate copolymers are commercially available, for example, under the trade name of Escorene® (from Exxon Mobil), under the trade name of Primeva® (from Repsol Quimica S.A.), under the trade name of Evatane® (from Arkema Functional Polyolefins), under the trade name of Greenflex® (from Eni versalis S.p.A.), under the trade name of Levapren® (from Arlanxeo GmbH), and under the trade name of Elvaloy® (from Dupont).

According to one or more embodiments, the at least one ethylene vinyl acetate copolymer P11 comprises at least 15 wt.-%, preferably at least 25 wt.-%, more preferably at least 35 wt.-%, still more preferably at least 50 wt.-%, of the total weight of the at least one polymer P1.

According to one or more embodiments, the at least one polymer P1 further comprises at least one polymer P12 different from the at least one ethylene vinyl acetate copolymer P11, preferably selected from the group consisting of polyvinylchloride, polyolefins, halogenated polyolefins, and ketone ethylene esters.

Suitable polyolefins for use as the at least one polymer P12 include, for example, polyethylenes, ethylene copolymers, polypropylenes, and propylene copolymers.

Suitable polyethylenes include very-low-density polyethylene, low-density polyethylene, linear low-density polyethylene, medium-density polyethylene, high-density polyethylene, and ultra-high-molecular-weight polyethylene, particularly low-density polyethylene, linear low-density polyethylene, medium-density polyethylene, high-density polyethylene.

Suitable ethylene copolymers include random and block copolymers of ethylene and one or more C₃-C₂₀ α-olefin monomers, particularly one or more of propylene, 1-butene, 1-pentene, 1-hexene, 1-heptene, 1-octene, 1-decene, 1-dodecene, and 1-hexadodecene, preferably comprising at least 55 wt.-%, more preferably at least 65 wt.-%, of ethylene-derived units, based on the weight of the copolymer.

Suitable polypropylenes include, for example, isotactic polypropylene (iPP), syndiotactic polypropylene (sPP), and homopolymer polypropylene (hPP).

Suitable propylene copolymers include propylene-ethylene random and block copolymers and random and block copolymers of propylene and one or more C₄-C₂₀ α-olefin monomers, in particular one or more of 1-butene, 1-pentene, 1-hexene, 1-heptene, 1-octene, 1-decene, 1-dodecene, and 1-hexadodecene, preferably comprising at least 55 wt.-%, more preferably at least 65 wt.-%, of propylene-derived units, based on the weight of the copolymer.

Preferably, the at least one polymer P12 comprises not more than 75 wt.-%, preferably not more than 65 wt.-%, more preferably not more than 55 wt.-%, even more preferably not more than 45 wt.-%, of the total weight of the at least one polymer P1. According to one or more embodiments, the at least one polymer P12 comprises 2.5-65 wt.-%, preferably 5-55 wt.-%, more preferably 10-50 wt.-%, even more preferably 15-45 wt.-%, of the total weight of the at least one polymer P1.

The filled polymeric layer further comprises at least one inorganic filler F. According to one or more embodiments, the particles of the at least one inorganic filler F are distributed throughout the entire volume of the filled polymeric layer. The term “distributed throughout” means that essentially all portions of the filled polymeric layer contain particles of the at least one inorganic filler but it does not necessarily imply that the distribution of the particles is completely uniform throughout the filled polymeric layer.

It may also be preferable that the filled polymeric layer comprises a homogeneously mixed mixture of the at least one polymer P1 and the at least one inorganic filler F. A “homogeneously mixed mixture” refers in the present disclosure to compositions, in which the individual constituents are distributed substantially homogeneously in the composition. A homogeneously mixed mixture of the at least one polymer P1 and the at least one inorganic filler F refers, therefore, to compositions in which the particles of the at least one inorganic filler F are homogeneously/uniformly distributed in a polymer phase comprising the at least one polymer P1. For a person skilled in the art it is clear that within such mixed compositions there may be regions formed, which have a slightly higher concentration of one of the constituents than other regions and that a 100% homogeneous distribution of all the constituents is generally not achievable. Such mixed compositions with “imperfect” distribution of constituents, however, are also intended to be included by the term “homogeneously mixed mixture” in accordance with the present invention.

Preferably, the at least one inorganic filler F has:
a d₉₈ particle size of not more than 500 μm, more preferably not more than 350 μm, even more preferably not more than 250 μm, still more preferably not more than 100 μm and/or
a median particle size d₅₀ of not more than 150 μm, more preferably not more than 100 μm, even more preferably not more than 50 μm, still more preferably not more than 25 μm and/or
d₁₀ particle size of not more than 25 μm, more preferably not more than 15 μm, even more preferably not more than 5 μm, still more preferably not more than 2.5 μm.

The term “particle size” refers in the present disclosure to the area-equivalent spherical diameter of a particle (Xₐᵣₑₐ). The term d₉₀ particle size refers in the present disclosure to a particle size below which 90% of all particles by volume are smaller than the d₉₀ value. In analogy, the term “median particle size d₅₀” refers to a particle size below which 50% of all particles by volume are smaller than the d₅₀ value and the term “d₁₀ particle size” refers to a particle size below which 10% of all particles by volume are smaller than the d₁₀ value. A particle size distribution can be measured by laser diffraction according to the method as described in standard ISO 13320:2009 using a wet or dry dispersion method and a Mastersizer 2000 device (trademark of Malvern Instruments Ltd, GB).

According to one or more embodiments, the at least one inorganic filler F has a median particle size d₅₀ in the range of 0.1-50 μm, preferably 0.15-35 μm, more preferably 0.25-25 μm, even more preferably 0.35-20 μm, still more preferably 0.35-15 μm, most preferably 0.5-10 μm. According to one or more embodiments, the at least one inorganic filler F is selected from the group consisting of inert mineral fillers and mineral binders.

According to one or more embodiment, the at least one inorganic filler F comprises at least one inert mineral filler F1.

The term “inert mineral filler” refers to mineral fillers, which, unlike mineral binders do not undergo a hydration reaction in the presence of water. Suitable mineral fillers to be used as the at least one inorganic filler include, for example, sand, granite, calcium carbonate, magnesium carbonate, clay, expanded clay, diatomaceous earth, pumice, mica, kaolin, dolomite, xonotlite, perlite, vermiculite, Wollastonite, barite, cristobalite, silica, fumed silica, fused silica, glass beads, hollow glass spheres, ceramic spheres, bauxite, comminuted concrete, and zeolites.

The term “sand” refers in the present document mineral clastic sediments (clastic rocks) which are loose conglomerates (loose sediments) of round or angular small grains, which were detached from the original grain structure during the mechanical and chemical degradation and transported to their deposition point, said sediments having an SiO₂ content of greater than 50 wt.-%, in particular greater than 75 wt.-%, particularly preferably greater than 85 wt.-%. The term “calcium carbonate” when used as inert mineral filler refers to solid particulate substances produced from chalk, limestone, or marble by grinding and/or precipitation.

According to one or more embodiments, the at least one inert mineral filler F1 is selected from the group consisting of sand, granite, calcium carbonate, magnesium carbonate, clay, expanded clay, diatomaceous earth, pumice, mica, kaolin, potash, dolomite, xonotlite, perlite, vermiculite, Wollastonite, barite, cristobalite, silica (quartz), fumed silica, fused silica, bauxite, comminuted concrete, and zeolites, preferably from the group consisting of calcium carbonate, magnesium carbonate, diatomaceous earth, pumice, mica, dolomite, xonotlite, perlite, vermiculite, Wollastonite, barite, and comminuted concrete.

According to one or more embodiments, the at least one inorganic filler F is composed of the at least one inert mineral filler F1.

According to one or more embodiment, the at least one inorganic filler F comprises at least one mineral binder F2.

The term “mineral binder” refers in the present disclosure to mineral materials, which undergo a hydration reaction in the presence of water. Particularly, the term “mineral binder” refers to non-hydrated mineral binders, i.e. to unreacted mineral binders that have not yet reacted in a hydration reaction.

Suitable mineral binders for use as the at least one inorganic filler F include hydraulic binders, such as cement and hydraulic lime, calcium sulfates, and air-hardening binders, such as non-hydrated lime, and latent hydraulic and pozzolanic binder materials.

According to one or more embodiment, the at least one mineral binder F2 comprises at least one hydraulic binder. Suitable hydraulic binders for use as the at least one mineral binder F2 include the ones suitable for use as the at least one hydraulic binder H, as discussed above.

According to one or more embodiments, the at least one mineral binder F2 comprises at least one non-hydraulic binder. Examples of suitable non-hydraulic binders to be used as the at least one mineral binder F2 include air-slaked lime (non-hydraulic lime) and calcium sulfate. The term “calcium sulfate” is understood to include calcium sulfate anhydride (CaSO₄), calcium sulfate hemihydrate (CaSO₄·½H₂O), and calcium sulfate dihydrate (CaSO₄·2H₂O). Furthermore, the term “calcium sulfate hemihydrate” is understood to include both alpha and beta calcium sulfate hemihydrates. Preferred calcium sulfates include the ones derived from REA gypsum, phosphor gypsum, and nature gypsum. The term “REA gypsum” refers here to a gypsum obtained in so-called flue gas desulphurization plants. The at least one inorganic filler F is preferably present in the filled polymeric layer as individual solid particles and/or as aggregates of one or more solid particles, wherein at least a portion of the solid particles and/or aggregates are dispersed in a continuous phase comprising the at least one polymer P1. The expression “dispersed in a continuous phase” is understood to mean that the individual solid particles or aggregates of one or more solid particles are at least partially, preferably completely surrounded by the continuous phase comprising the at least one polymer P1.

According to one or more embodiments at least 50 wt.-%, preferably at least 75 wt.-%, more preferably at least 95 wt.-%, even more preferably at least 99 wt.-%, still more preferably at least 99.9 wt.-%, of the particles of the at least one inorganic filler F are dispersed in a continuous phase comprising the at least one polymer P1.

According to one or more embodiments, the mass per unit area of the filled polymeric layer is in the range of 100-10000 g/m², preferably 150-7500 g/m², more preferably 200-5000 g/m², even more preferably 250-3500 g/m², still more preferably 300-2500 g/m², most preferably 350-1500 g/m².

According to one or more embodiments, the sealing element is composed of the contact layer, wherein the contact layer is composed of the filled polymeric layer.

The filled polymeric layer can be obtained, for example, by using a method comprising a step of extruding or co-extruding a first molten polymer composition comprising the constituents of the filled polymeric layer through an extruder die.

The first molten polymer composition is preferably obtained by melt-processing a first starting composition comprising the constituents of the filled polymeric layer. The term “melt-processing” refers in the present disclosure to a process, in which at least one molten polymeric component is intimately mixed with at least one other component, which may be another molten polymeric component or a solid component, such as a filler or an additive, until a melt blend, i.e. a substantially homogeneously mixed mixture of the polymeric component(s) and the other constituents is obtained.

The melt processing of a starting composition can be conducted as a batch process using any conventional mixer, such as a Brabender, Banbury, or roll mixer or as continuous process using a continuous type mixer, preferably an extruder, such as a single screw or a twin-screw extruder or a planetary roller extruder. The constituents of the starting composition are preferably fed into the mixer using a conventional feeding system comprising a feed hopper and feed extruder. Alternatively, some or all the constituents of the starting composition may be directly fed into the mixer as individual streams, as a pre-mix, a dry blend, or as a master batch. Furthermore, the constituents of the starting composition can first be processed in a compounding extruder to pellets or granules, which are then fed into the mixer.

Especially in case the at least one inorganic filler F comprises hydraulic binders, it may be preferred that the first starting composition contains only minor amounts of water. According to one or more embodiments, the first starting composition comprises less than 10 wt.-%, preferably less than 7.5 wt.-%, more preferably less than 5 wt.-%, even more preferably less than 3.5 wt.-%, still more preferably less than 2.5 wt.-%, of water, based on the total weight of the first starting composition.

The first molten polymeric composition is preferably extruded or co-extruded using an extrusion apparatus comprising an extruder and a die.

Such extrusion apparatuses are well known to a person skilled in the art. A suitable extruder comprises a barrel and a screw unit contained in the barrel or a ram. Any conventional extruders, for example, a ram extruder, single screw extruder, or a twin-screw extruder may be used. Preferably, the extruder is a screw extruder, more preferably a twin-screw extruder. The screw unit of a conventional screw extruder is typically considered to comprise feed, transition, and metering sections. In the feed section the thermoplastic composition enters the channels of the rotating screw and is conveyed towards the transition section, in which the composition is compressed and melted. The composition should be fully melted when it leaves the transition section. The function of the metering section is to homogenize the melted composition and to allow it to be metered or pumped out at constant rate. The extrusion apparatus further comprises a die, preferably a flat die, consisting of manifold, approach, and lip regions. In case of a co-extrusion process, the extrusion apparatus preferably comprises at least two extruders, preferably twin-screw extruders, and a single- or a multi-manifold die.

The extruder barrel comprises a feed port through which the material to be extruded is fed to the extruder and an outlet port through which the material leaves the barrel. The outlet port is coupled with the die via a gate or adapter piece. A mixing device may be interposed between the barrel and the die. The feed port is typically connected with a hopper to which the material to be extruded is added. It is preferred that a screen pack and a breaker plate are positioned at the end of the barrel to avoid plugging in the nozzles. The extruder further comprises heating elements, cooling elements, temperature sensors and temperature control elements to provide temperature-controlled zones along the barrel, also known as barrel zones. The extruder may comprise, for example, 3 to 8 barrel zones, preferably at least 5 barrel zones, by the use of which a temperature profile can be realized in the barrel.

Preferably, a significant part, preferably the entire amount of the at least one polymer P1 is fed into the extruder through the feed port. It may be preferred that at least part of the at least one inorganic filler F is fed into the extruder through another port located downstream from the feed port. The term “downstream” designates in the present document the direction to the outlet port. For example, it may be advantageous that not more than 50 wt.-%, preferably not more than 30 wt.-%, more preferably not more than 10 wt.-%, of the total amount of the at least one inorganic filler F is fed into the extruder through the feed port with the entire amount of the polymer component and that the remaining portion of the at least one inorganic filler F is fed into the extruder through a another port located downstream from the feed port.

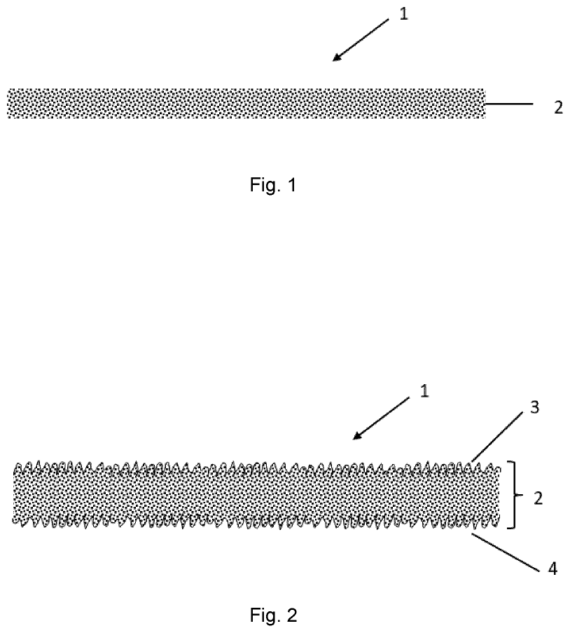

The upper and lower major surfaces of the filled polymeric layer may be substantially planar/smooth as shown in FIG. 1 or they can contain a surface structure (3, 4), which can be characterized as surface roughness, as shown in FIG. 2. The term “surface roughness” refers to unevenness of a surface, which can be quantified, for example, by use of two-dimensional (2D) surface roughness parameters as defined in ISO 4287 standard and/or with three-dimensional (3D) surface roughness parameters defined as defined in ISO 25178 standard.

According to one or more embodiments, the upper and/or lower major surfaces of the filled polymeric layer comprise a surface structure to enable increased bonding strength to the wet adhesive composition after hardening. The increased bonding strength to the wet adhesive composition may result from increased surface area of the filled polymeric layer, which enables the increased number of molecular interactions between the wet adhesive composition and the surface of the fills polymeric layer compared to a filled polymeric layer having a smooth surface.

A filled polymeric layer having a surface structure can be obtained, for example, by using a foam extrusion process comprising a step of extruding or co-extruding the first molten polymer composition comprising the constituents of the filled polymeric layer and a blowing gas through an extruder die. On the other hand, a filled polymeric layer having a smooth surface can also be subjected to a mechanical surface treatment step, such as grinding, brushing, and abrasive blasting to produce the desired surface structure.

In case the first molten polymer composition comprises a blowing gas, the melt-shaped layer discharged from the extruder die is first inflated due to volume increase of the blowing gas resulting in formation of a closed cell structure. Eventually, surface(s) of the melt-shaped layer is penetrated by the still expanding blowing gas, which results in formation of open or semi-open cells, pores, cavities, and other surface imperfections, which can be characterized as “a surface structure”.

Physical and chemical blowing agents may be used to provide the first molten polymer composition with a blowing gas. Chemical blowing agents are preferably added to the first starting composition and the blowing gas is then generated during the melt-processing of the first starting composition. Physical blowing agents are preferably added directly to the first molten polymeric composition before it is extruded through the extruder die.

Suitable physical blowing agents include gaseous and liquid physical blowing agents. Liquid physical blowing agents include volatile liquids which produce gas through vaporization. Suitable liquid physical blowing agents generally include water, short-chain aliphatic hydrocarbons, for example having from five to seven carbon atoms, and their halogenated, particularly chlorinated and fluorinated, derivatives. Particularly suitable liquid physical blowing agents have a standard boiling point measured at a pressure of 1 bar of not more than 250° C., preferably not more than 200° C. The standard boiling point of a liquid physical blowing agent can be measured using an ebulliometer. Gaseous physical blowing agents, such as compressed nitrogen or carbon dioxide, can be directly injected under high pressure into the polymer melt, which is conveyed through a melt-processing apparatus, such as an extruder barrel.

Chemical blowing agents, also known as chemical foaming agents, are typically solids that liberate gas(es) by means of a chemical reaction, such as decomposition, when exposed to elevated temperatures. Inorganic, organic, exothermic, and endothermic chemical blowing agents are all equally suitable. Endothermic blowing agents may be preferred over exothermic blowing agents, since the latter have been found to have potential to trigger respiratory sensitivity, are generally not safe from a toxicological point of view or have a risk of explosion. Furthermore, by-products such as ammonia, formamide, formaldehyde or nitrosamines are released during decomposition of exothermic blowing agents and these substances have been classified as hazardous substances.

In case of a foam extrusion process, the first starting composition preferably comprises at least one chemical blowing agent.

Suitable substances to be used as the at least one chemical blowing agent include, for example, azodicarbonamide, azobisisobutyronitrile, azocyclohexyl nitrile, dinitrosopentamethylene tetramine, azodiamino benzene, calcium azide, 4,4′-diphenyldisulphonyl azide, benzenesulphonyl hydrazide, 4,4-oxybenzenesulphonyl semicarbazide, 4,4-oxybis(benzenesulphonyl hydrazide), diphenyl sulphone-3,3-disulphonyl hydrazide, p-toluenesulphonyl hydrazide, p-toluenesulphonyl semicarbazide, trihydrazino triazine, N,N′-dimethyl-N,N′-dinitrosoterephthalamide, diazoaminobenzene, diazoaminotoluene, hydrazodicarbonamide, barium azodicarboxylate, 5-hydroxytetrazole, sodium bicarbonate, ammonium carbonate, ammonium bicarbonate, potassium bicarbonate, and organic acids.

The at least one chemical blowing agent, if used, preferably comprises not more than 3.5 wt.-%, more preferably not more than 2.5 wt.-%, even more preferably not more than 2 wt.-%, still more preferably not more than 1.5 wt.-%, of the total weight of the first starting composition.

According to one or more embodiments, the at least one chemical blowing agent comprises at least 0.05 wt.-%, preferably at least 0.1 wt.-%, more preferably at least 0.15 wt.-%, of the total weight of the first starting composition. According to one or more further embodiments, the at least one chemical blowing agent comprises 0.01-2.5 wt.-%, preferably 0.1-2.0 wt.-%, more preferably 0.15-1.5 wt.-%, even more preferably 0.25-1.25 wt.-%, still more preferably 0.35-1.25 wt.-%, of the total weight of the first starting composition.

Regarding the extrusion or co-extrusion process, it may also be preferable that only a portion of the at least one chemical blowing agent, if used, is fed into the extruder through the feed port and that at least 10 wt.-%, preferably at least 20 wt. % of the total amount of it is fed into the extruder through another port located downstream from the feed port.

The preferred extrusion temperature depends on the embodiment of the filled polymeric layer, in particular on the type of the at least one polymer P1. The term “extrusion temperature” refers to the temperature of the extruded composition in the die outlet. According to one or more embodiments, the extrusion temperature is in the range of 100-250° C., preferably 120-240° C., more preferably 125-220° C., even more preferably 135-200° C.

The preferred extrusion pressure depends on the embodiment of the filled polymeric layer, particularly on the type of the at least one polymer P1 and on the amount of the at least one inorganic filler F in the first starting composition. The term “extrusion pressure” refers to the pressure of the composition at the end of the metering zone just before the composition enters the die inlet.

According to one or more embodiments, the extrusion pressure is in the range of 20-350 bar, preferably 30-240 bar, more preferably 35-200 bar, even more preferably 40-130 bar.

Preferably, at least part, such as at least 5 wt.-%, in particular at least 10 wt.-%, preferably 25 wt.-%, more preferably at least 50 wt.-%, most preferably at least 75 wt.-%, of the at least one chemical blowing agent, if used, decomposes while the first molten polymer composition is conveyed through the barrel and before it enters the extruder die. This is ensured by selection of a suitable chemical blowing agent or a suitable mixture of a chemical blowing agent and an activator and by adjusting the temperature profile in the feed, transition, and metering sections. Preferably, the first molten polymer composition is maintained at a temperature, which is at least 10° C. above the decomposition temperature of the at least one chemical blowing agent as the first molten polymer composition is conveyed through the extruder barrel.

Furthermore, the extruder is preferably operated with closed venting unit(s). It is essential that at least a significant part of the blowing gases released inside the extruder barrel are kept trapped in the first molten polymer composition and not released before it exits the extruder die. According to one or more embodiments, the contact layer comprises or is composed of a bitumen-based layer.

According to one or more embodiments, the bitumen-based layer comprises:
At least 35 wt.-%, preferably at least 50 wt.-%, of bitumen B and
5-35 wt.-%, preferably 10-30 wt.-%, of at least one modifying polymer MP, all proportions being based on the total weight of the bitumen-based layer.

The term “bitumen” designates in the present disclosure blends of heavy hydrocarbons, having a solid consistency at room temperature, which are normally obtained as vacuum residue from refinery processes, which can be distillation (topping or vacuum) and conversion (thermal cracking and visbreaking) processes of suitable crude oils. Furthermore, the term “bitumen” also designates natural and synthetic bitumen as well as bituminous materials obtained from the extraction of tars and bituminous sands.

The bitumen B can comprise one of more different types of bitumen materials, such as penetration grade (distillation) bitumen, air-rectified (semi-blown) bitumen, and hard grade bitumen.

The term “penetration grade bitumen” refers here to bitumen obtained from fractional distillation of crude oil. A heavy fraction composed of high molecular weight hydrocarbons, also known as long residue, which is obtained after removal of gasoline, kerosene, and gas oil fractions, is first distilled in a vacuum distillation column to produce more gas oil, distillates, and a short residue. The short residue is then used as a feed stock for producing different grades of bitumen classified by their penetration index, typically defined by a PEN value, which is the distance in tenth millimeters (dmm) that a needle penetrates the bitumen under a standard test method. Penetration grade bitumen are characterized by penetration and softening point. The term “air-rectified bitumen” or “air-refined bitumen” refers in the present disclosure to a bitumen that has been subjected to mild oxidation with the goal of producing a bitumen that meets paving-grade bitumen specifications. The term “hard grade bitumen” refers in the present disclosure to bitumen produced using extended vacuum distillation with some air rectification from propane-precipitated bitumen. Hard bitumen typically has low penetration values and high softening-points.

According to one or more embodiments, the bitumen B comprises at least 75 wt.-%, preferably at least 85 wt.-%, more preferably at least 90 wt.-% of at least one penetration grade bitumen, preferably having a penetration value in the range of 30-300 dmm, more preferably 70-220 dmm, even more preferably 100-160 dmm and/or a softening point determined by Ring and Ball measurement conducted according to DIN EN 1238 standard in the range of 30-100° C., more preferably 30-70° C., even more preferably 30-50° C.

Suitable compounds for use as the modifying polymer MP include, for example, polyolefins, such as atactic polypropylene (APP), amorphous polyolefins (APO), styrene block copolymers, and rubbers.

The term “amorphous polyolefin (APO)” refers in the present disclosure to polyolefins to having a low crystallinity degree determined by a differential scanning calorimetry (DSC) measurements, such as in the range of 0.001-10 wt.-%, preferably 0.001-5 wt.-%. The crystallinity degree of a polymer can be determined by using the differential scanning calorimetry measurements conducted according to ISO 11357 standard to determine the heat of fusion, from which the degree of crystallinity is calculated. In particular, the term “amorphous polyolefin” designates poly-α-olefins lacking a crystalline melting point (Tₘ) as determined by differential scanning calorimetric (DSC) or equivalent technique.

Suitable amorphous polyolefins for use as the modifying polymer MP include, for example, amorphous propene rich copolymers of propylene and ethylene, amorphous propene rich copolymers of propylene and butene, amorphous propene rich copolymers of propylene and hexene, and amorphous propene rich terpolymers of propylene, ethylene, and butene. The term “propene rich” is understood to mean copolymers and terpolymers having a content of propene derived units of at least 50 wt.-%, preferably at least 65 wt.-%, more preferably at least 70 wt.-%, based on total weight of the copolymer/terpolymer.

Suitable styrene block copolymers for use as the modifying polymer MP include, particularly styrene block copolymers of the SXS type, in each of which S denotes a non-elastomer styrene (or polystyrene) block and X denotes an elastomeric α-olefin block, which may be polybutadiene, polyisoprene, polyisoprene-polybutadiene, completely or partially hydrogenated polyisoprene (poly ethylene-propylene), or completely or partially hydrogenated polybutadiene (poly ethylene-butylene). The elastomeric α-olefin block preferably has a glass transition temperature in the range from −55° C. to −35° C. The elastomeric α-olefin block may also be a chemically modified α-olefin block. Particularly suitable chemically modified α-olefin blocks include, for example, maleic acid-grafted α-olefin blocks and particularly maleic acid-grafted ethylene-butylene blocks. Preferred styrene block copolymers for use as the modifying polymer MP include at least styrene-butadiene-styrene (SBS), styrene-isoprene-styrene (SIS), styrene-isoprene-butadiene-styrene (SIBS), styrene-ethylene-butadiene-styrene (SEBS), and styrene-ethylene-propene-styrene (SEPS) block copolymers, preferably having a linear, radial, diblock, triblock or a star structure.

Particularly suitable rubbers for use as the modifying polymer MP include, for example, styrene-butadiene rubber (SBR), ethylene propylene diene monomer rubber (EPDM), polyisoprene, polybutadiene, natural rubber, polychloroprene rubber, ethylene-propylene rubber (EPR), nitrile rubbers, and acrylic rubbers.

According to one or more embodiments, the at least one modifying polymer MP is selected from the group consisting of atactic polypropylene (APP), amorphous polyolefins (APO), styrene-butadiene-styrene (SBS) block copolymer, styrene-isoprene-styrene (SIS) block copolymer, styrene-butadiene rubber (SBR), ethylene propylene diene monomer (EPDM) rubber, polyisoprene, polybutadiene, natural rubber, polychloroprene rubber, ethylene-propylene rubber (EPR), nitrile rubbers, and acrylic rubbers, preferably from the group consisting of atactic polypropylene (APP), amorphous polyolefins (APO), styrene-butadiene-styrene (SBS) block copolymer, styrene-isoprene-styrene (SIS) block copolymer, and styrene-butadiene rubber (SBR).

According to one or more embodiments, the bitumen-based layer is a styrene butadiene styrene (SBS) modified bituminous sheet comprising a glass fiber reinforcements according to ASTM D6163/D6163M-21 standard or a styrene butadiene styrene (SBS) modified bituminous sheet comprising a polyester reinforcement according to ASTM D6164/D6164M-21 standard.

According to one or more embodiments, the contact layer comprises or is composed of a layer of a pressure sensitive adhesive.

The term “pressure sensitive adhesive” refers in the present disclosure to viscoelastic materials, which adhere immediately to almost any kind of substrates by application of light pressure, and which are permanently tacky.

Suitable pressure sensitive adhesives for use in the contact layer include adhesives based on styrene block copolymers, amorphous polyolefins (APO), amorphous poly-alpha-olefins (APAO), vinyl ether polymers, and elastomers such as, for example, styrene-butadiene rubber (SBR), ethylene propylene diene monomer (EPDM) rubber, butyl rubber, polyisoprene, polybutadiene, natural rubber, polychloroprene rubber, ethylene-propylene rubber (EPR), nitrile rubber, acrylic rubber, ethylene vinyl acetate (EVA) rubber, and silicone rubber.

In addition to the above-mentioned polymers, suitable pressure sensitive adhesives typically comprise one or more additional components including, for example, tackifying resins, waxes, and additives, for example, UV-light absorption agents, UV- and heat stabilizers, optical brighteners, pigments, dyes, and desiccants.

The term “tackifying resin” designates in the present disclosure resins that in general enhance the adhesion and/or tackiness of an adhesive composition. The term “tackiness” designates in the present disclosure the property of a substance of being sticky or adhesive by simple contact. The tackiness can be measured, for example, as a loop tack. Preferred tackifying resins are tackifying at a temperature of 25° C. Examples of suitable tackifying resins include natural resins, synthetic resins and chemically modified natural resins.

Examples of suitable natural resins and chemically modified natural resins include rosins, rosin esters, phenolic modified rosin esters, and terpene resins. The term “rosin” is to be understood to include gum rosin, wood rosin, tall oil rosin, distilled rosin, and modified rosins, for example dimerized, hydrogenated, maleated and/or polymerized versions of any of these rosins.

Suitable terpene resins include copolymers and terpolymers of natural terpenes, such as styrene/terpene and alpha methyl styrene/terpene resins; polyterpene resins generally resulting from the polymerization of terpene hydrocarbons, such as the bicyclic monoterpene known as pinene, in the presence of Friedel-Crafts catalysts at moderately low temperatures; hydrogenated polyterpene resins; and phenolic modified terpene resins including hydrogenated derivatives thereof.

The term “synthetic resin” refers to compounds obtained from the controlled chemical reactions such as polyaddition or polycondensation between well-defined reactants that do not themselves have the characteristic of resins. Monomers that may be polymerized to synthesize the synthetic resins may include aliphatic monomer, cycloaliphatic monomer, aromatic monomer, or mixtures thereof. Aliphatic monomers can include C₄, C₅, and C₆ paraffins, olefins, and conjugated diolefins. Examples of aliphatic monomer or cycloaliphatic monomer include butadiene, isobutylene, 1,3-pentadiene, 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, dicyclopentadiene, and terpenes. Aromatic monomer can include C₈, C₉, and C₁₀ aromatic monomer. Examples of aromatic monomer include styrene, indene, derivatives of styrene, derivatives of indene, coumarone and combinations thereof.

Particularly suitable synthetic resins include synthetic hydrocarbon resins made by polymerizing mixtures of unsaturated monomers that are obtained as by-products of cracking of natural gas liquids, gas oil, or petroleum naphthas. Synthetic hydrocarbon resins obtained from petroleum-based feedstocks are referred in the present disclosure as “hydrocarbon resins” or “petroleum hydrocarbon resins”. These include also pure monomer aromatic resins, which are made by polymerizing aromatic monomer feedstocks that have been purified to eliminate color causing contaminants and to precisely control the composition of the product. Hydrocarbon resins typically have a relatively low average molecular weight (Mₙ), such in the range of 250-5000 g/mol and a glass transition temperature, determined by dynamical mechanical analysis (DMA) as the peak of the measured loss modulus (G″) curve using an applied frequency of 1 Hz and a strain level of 0.1%, of above 0° C., preferably equal to or higher than 15° C., more preferably equal to or higher than 30° C.

Examples of suitable hydrocarbon resins include C5 aliphatic hydrocarbon resins, mixed C5/C9 aliphatic/aromatic hydrocarbon resins, aromatic modified C5 aliphatic hydrocarbon resins, cycloaliphatic hydrocarbon resins, mixed C5 aliphatic/cycloaliphatic hydrocarbon resins, mixed C9 aromatic/cycloaliphatic hydrocarbon resins, mixed C5 aliphatic/cycloaliphatic/C9 aromatic hydrocarbon resins, aromatic modified cycloaliphatic hydrocarbon resins, C9 aromatic hydrocarbon resins, polyterpene resins, and copolymers and terpolymers of natural terpenes as well hydrogenated versions of the aforementioned hydrocarbon resins. The notations “C5” and “C9” indicate that the monomers from which the resins are made are predominantly hydrocarbons having 4-6 and 8-10 carbon atoms, respectively. The term “hydrogenated” includes fully, substantially and at least partially hydrogenated resins. Partially hydrogenated resins may have a hydrogenation level, for example, of 50%, 70%, or 90%.

Suitable hydrocarbon resins are commercially available, for example, under the trade name of Wingtack® series, Wingtack® Plus, Wingtack® Extra, and Wingtack® STS (all from Cray Valley); under the trade name of Escorez® 1000 series, Escorez® 2000 series, and Escorez® 5000 series (all from Exxon Mobile Chemical); under the trade name of Novares® T series, Novares® TT series, Novares® TD series, Novares® TL series, Novares® TN series, Novares® TK series, and Novares® TV series (all from RUTGERS Novares GmbH); and under the trade name of Kristalex®, Plastolyn®, Piccotex®, Piccolastic® and Endex® (all from Eastman Chemicals).

The sealing element can be composed of the contact layer or comprise further layers, such as one or more waterproofing layers. In the absence of separate waterproofing layers, the contact layer is preferably a bi-functional layer, which provides the sealing element with sufficient waterproofing properties in addition to being operative to form a bond with the wet adhesive composition after hardening.

According to one or more preferred embodiments, the sealing element comprises further a waterproofing layer having upper and lower major surfaces and comprising at least one polymer P2 or bitumen B.

The contact layer and the waterproofing layer can be directly or indirectly connected to each other over at least a portion of their opposing major surfaces.

The contact layer and the waterproofing layer can be indirectly connected to each other, for example, via a connecting layer, such as a layer of adhesive. In case a porous contact layer, the contact layer may be partially directly connected and partially indirectly connected to the waterproofing layer.

The expression “directly connected” is understood to mean in the context of the present invention that no further layer or substance is present between the layers, and that the opposing surfaces of the two layers are directly connected to each other or adhere to each other. At the transition area between the two layers, the materials forming the layers can also be present mixed with each other.

According to one or more embodiments, at least a portion of the upper major surface of the waterproofing layer is directly connected to a bottom major surface of the contact layer. According to one or more embodiments, at least 50%, preferably at least 75 wt.-%, more preferably at least 95%, of the area of the upper major surface of the waterproofing layer is directly connected to the lower major surface of the contact layer.

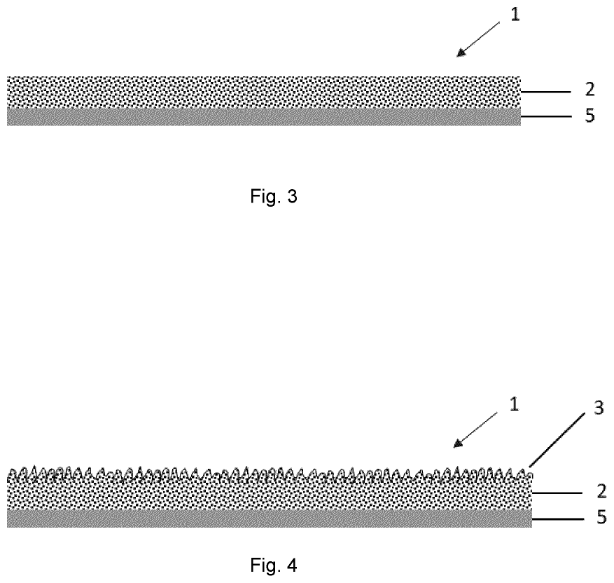

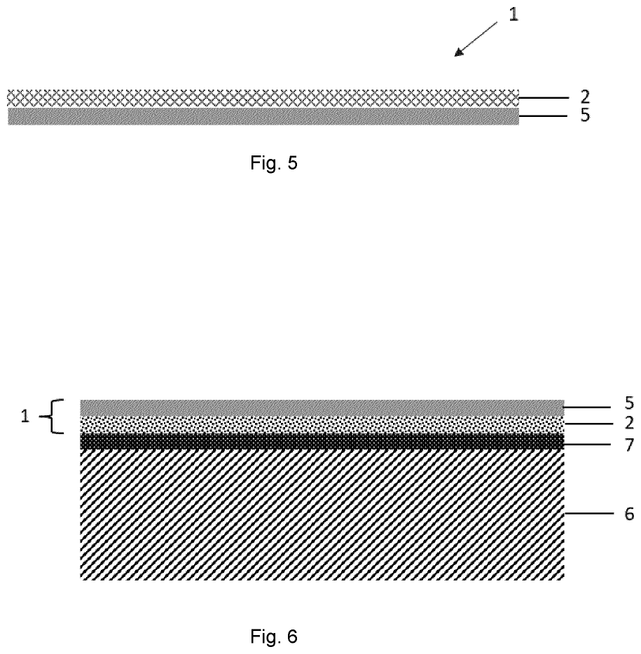

In case the contact layer is composed of the filled polymeric layer, the upper major surface of the filled polymeric layer on the side opposite to the side of the waterproofing layer may be substantially planar/smooth as shown in FIG. 3 or it can contain a surface structure (3), which can be characterized as surface roughness, as shown in FIG. 4.

According to one or more embodiments, the upper major surface of the filled polymeric layer comprises a surface structure to enable increased bonding strength to the wet adhesive composition after hardening.

The preferred composition of the waterproofing layer is not particularly restricted, and it mainly depends on the composition of the contact layer. However, the waterproofing layer should be as waterproof as possible and not to decompose or be mechanically damaged even under prolonged influence of water or moisture.

It may generally be preferred that the waterproofing layer is in the form of a flexible plastic layer. This allows the sealing element to be wound into rolls, typically during production, transported the construction site, unwound from the rolls, and easily applied to a surface of a substrate to be sealed.

According to one or more embodiments, the waterproofing layer has a tensile modulus of elasticity determined according to EN ISO 527-3:2018 of not more than 750 MPa, preferably not more than 500 MPa, more preferably not more than 350 MPa, even more preferably not more than 250 MPa, still more preferably not more than 150 MPa.

According to one or more embodiments, the at least one polymer P2 is selected from the group consisting of polyvinylchloride, polyolefins, halogenated polyolefins, rubbers, and ketone ethylene esters.

According to one or more embodiments, the at least one polymer P2 is selected from the group consisting of polyvinylchloride, ethylene vinyl acetate copolymers, ethylene-acrylic ester copolymers, ethylene-α-olefin copolymers, propylene-α-olefin copolymers, polyethylene, polypropylene, chlorosulfonated polyethylene, ethylene propylene diene monomer rubber, styrene-butadiene rubber (SBR), and polyisobutylene (PIB), preferably from the group consisting of polyvinylchloride, ethylene vinyl acetate copolymers, ethylene-acrylic ester copolymers, ethylene-α-olefin copolymers, propylene-α-olefin copolymers, polyethylene, polypropylene, chlorosulfonated polyethylene.

Preferably, the at least one polymer P2 or bitumen B comprises at least 5 wt.-%, more preferably at least 15 wt.-%, even more preferably at least 25 wt.-%, still more preferably at least 35 wt.-%, most preferably at least 50 wt.-%, of the total weight of the waterproofing layer. According to one or more embodiments, the at least one polymer P2 comprises 15-97.5 wt.-%, preferably 25-95 wt.-%, more preferably 35-95 wt.-%, even more preferably 50-90 wt.-%, of the total weight of the waterproofing layer.

The waterproofing layer may further comprise one or more additives such as fillers, UV- and heat stabilizers, antioxidants, flame retardants, dyes, pigments such as titanium dioxide, matting agents, antistatic agents, impact modifiers, biocides, and processing aids such as lubricants, slip agents, antiblock agents, and denest aids. It is however preferred, that the total amount of these types of additives comprises not more than 65 wt.-%, preferably not more than 55 wt.-%, more preferably not more than 45 wt.-%, of the total weight of the waterproofing layer.

The thickness of the waterproofing layer is not subjected to any particular restrictions. However, sealing elements comprising a waterproofing layer having a thickness of above 15 mm or below 0.01 mm are usually not suitable for use as membranes. Preferably, the waterproofing layer has a thickness of at least 0.05 mm, more preferably at least 0.1 mm, even more preferably at least 0.15 mm. According to one or more embodiments, the waterproofing layer has a thickness in the range of 0.05-15 mm, preferably 0.1-10 mm, more preferably 0.15-5 mm, even more preferably 0.25-3.5 mm, still more preferably 0.35-2.5 mm. The thickness of the waterproofing layer can be determined by using a measurement method as defined in DIN EN 1849-2-2019-09 standard.

According to one or more embodiments, the sealing element comprises the filled polymeric layer and the waterproofing layer, wherein the mass per unit area of the filled polymeric layer is in the range of 100-2500 g/m², preferably 150-1500 g/m², more preferably 200-1250 g/m², even more preferably 250-1000 g/m², still more preferably 300-1000 g/m², most preferably 350-850 g/m².

There are no strict limitations for the width and length of the sealing element, and these depend on its intended use. The term “width” and “length” refer here to the two perpendicular dimensions measured in the horizontal plane of the top and bottom surfaces of a sheet-like element. Generally, the “width” of a sheet like element is the smaller of the horizontal dimensions of the sheet-like element. Consequently, the “width” of the sealing element refers to the minor dimension measured in the horizontal plane of an outer major surface in a direction perpendicular to the length of the sealing element.

According to one or more embodiments, the sealing element is provided in form of a narrow strip having a width in the range of 10-500 mm, preferably 50-350 mm, more preferably 75-300 mm. According to one or more further embodiments, the sealing element is provided in form of a broad sheet having a width in the range of 0.75-5 m, preferably 0.85-3.5 m, more preferably 1-2.5 m.

A sealing element comprising a filled polymeric layer and a waterproofing layer can be obtained, for example, by co-extruding a first molten polymer composition comprising the constituents of the filler polymeric layer and a second molten polymer composition comprising the constituents of the waterproofing layer.

A sealing element comprising a filled polymeric layer and a waterproofing layer, wherein the upper major surface of the filler polymeric layer comprises a surface structure, can be obtained, for example, by co-extruding a first molten polymer composition comprising the constituents of the filler polymeric layer and a blowing gas and a second molten polymer composition comprising the constituents of the waterproofing layer.

According to one or more embodiments, the sealing element comprises, in addition to the contact layer and the waterproofing layer, a further contact layer, wherein the further contact layer and the waterproofing layer are directly or indirectly connected to each other over at least a portion of their opposing surfaces.

According to one or more embodiments, at least a portion of the lower major surface of the waterproofing layer is directly connected to the upper major surface of the further contact layer. According to one or more embodiments, at least 50%, preferably at least 75 wt.-%, more preferably at least 95% of the area of the lower major surface of the waterproofing layer is directly connected to the upper major surface of the further contact layer.

According to one or more embodiments, the further contact layer is a filled polymeric layer preferably comprising:
25-95 wt.-%, preferably 30-90 wt.-%, of the at least one polymer P1,
5-75 wt.-%, preferably 10-70 wt.-%, of the at least one solid inorganic filler F, all proportions being based on the total weight of the filled polymeric layer.

The lower major surface of the filled polymeric layer of the further contact layer on the side opposite to the side of the waterproofing layer may be substantially planar/smooth or it can contain a surface structure, which can be characterized as surface roughness.

The preferences given above for the at least one synthetic resin SP, the at least one hydraulic binder H, the contact layer, the waterproofing layer, and to the further contact layer, apply equally apply equally to all subjects of the present invention unless otherwise stated.

Another subject of the present invention is a sealed structure obtained by using the method for bonding a sealing element to a substrate of the present invention.

Still another subject of the present invention is use of a wet adhesive composition obtained by mixing an adhesive composition with water for bonding of a sealing element to a surface of a substrate, wherein the adhesive composition comprises:
a) 2.5-50 wt.-%, preferably 5-45 wt.-%, of at least one synthetic organic polymer SP and
b) 25-95 wt.-%, 35-90 wt.-%, of at least one hydraulic binder H, said proportions being based on the total weight of the adhesive composition.

According to one or more embodiments, the substrate is a concrete body, preferably a green concrete body.

According to one or more preferred embodiments, the substrate has a surface moisture content determined according to ASTM F2659 standard of at least 2 wt.-% of water, preferably at least 3 wt.-% of water, more preferably at least 4 wt.-% of water, even more preferably at least 5 wt.-% of water, particularly in the range of 2-16 wt.-% of water, preferably 2-12 wt.-% of water, more preferably 3-10 wt.-% of water, even more preferably 4-8 wt.-% of water.

The concrete body can form a part of any structural or civil engineering structure, which is to be sealed against water, moisture, harmful gases, or volatile organic compounds, such as an above ground or underground structure, for example, a base slab, wall, floor, basement, tunnel, wet room, building facade, flat or low-sloped roof, landfill, water-retaining structure, pond, or a dike.

According to one or more embodiments, the adhesive composition comprises:
a) 5-35 wt.-%, preferably 7.5-30 wt.-%, more preferably 10-30 wt.-%, even more preferably 10-25 wt.-%, most preferably 10-20 wt.-%, of the at least one synthetic organic polymer SP and
b) 40-90 wt.-%, preferably 50-90 wt.-%, more preferably 60-90 wt.-%, even more preferably 65-90 wt.-%, most preferably 70-90 wt.-%, of the at least one hydraulic binder H, said proportions being based on the total weight of the adhesive composition.

According to one or more embodiments, the sealing element is selected from the group consisting of a waterproofing membrane, roofing membrane, gas barrier membrane, volatile organic compound (VOC) barrier membrane, vapor barrier membrane, vapor retarder membrane, façade membrane, and a geomembrane.

Preferably, the sealing element comprises an outer major surface, which is operative to form a bond with the wet adhesive composition after hardening. Preferably, the wet adhesive composition is applied to a surface of the substrate or to the outer major surface of the sealing element to form a wet adhesive layer, which after joining of the sealing element with the substrate forms an interlayer between the sealing element and the substrate, and which after hardening effects adhesive bonding between sealing element and the substrate.

According to one or more embodiments, the sealing element comprises a contact layer. In these embodiments, one of the outer major surfaces of the contact layer preferably forms the outer major surface of sealing element that is operative to form a bond with the wet adhesive composition after hardening.

According to one or more embodiments, the contact layer comprises a layer of fiber material and/or a filled polymeric layer comprising 25-95 wt.-%, preferably 30-90 wt.-%, of at least one polymer P1 and 5-75 wt.-%, preferably 10-70 wt.-%, of at least one inorganic filler F, said proportions being based on the total weight of the filled polymeric layer.

According to one or more further embodiments, the sealing element further comprises a waterproofing layer having upper and lower major surfaces and comprising at least one polymer P2.
According to one or more embodiments, at least a portion of the upper major surface of the waterproofing layer is directly connected to a bottom major surface of the contact layer. According to one or more embodiments, at least 50%, preferably at least 75 wt.-%, more preferably at least 95%, of the area of the upper major surface of the waterproofing layer is directly connected to the lower major surface of the contact layer.

The preferred embodiments of the at least one synthetic organic polymer SP, of the at least one hydraulic binder H, the contact layer, the at least one polymer P1 the at least one inorganic filler F, the waterproofing layer, and the at least one polymer P2, have already been discussed above.

### Examples

The followings compounds shown in Table 1 were used in the examples:

TABLE 1

| | | |
|---|---|---|
| SP1 | Vinnapas ® 8620 E | Wacker Chemie |

| | |
|---|---|
| CAC | Calcium aluminate cement |
| OPC | Portland cement Type I/II |
| Additive 1 | Calcium sulfate (Gypsum) |
| Additive 2 | Potassium bitartrate |
| Additive 3 | Viscosity modifier |

### Preparation of Adhesive Compositions

The one-component adhesive compositions were prepared by dosing the raw materials in a ploughshare mixer and mixing until homogenously mixed mixture was obtained. The prepared dry mixtures were filled into a paper bag.

### Adhesive Properties

Adhesive properties were determined by measuring peel strengths with test specimens obtained by bonding of sealing elements using the adhesive compositions to cementitious substrates. A commercially available waterproofing membrane SikaProof® A+ (from Sika Schweiz AG) comprising a waterproofing layer and a hybrid (polymeric) contact layer was used as the sealing element. SikaGrout® 212 (from Sika USA) was used for preparing all cementitious substrates. Constituents of the tested adhesive compositions and measured peel strengths are presented in Tables 2 and 3.

The test specimens were prepared according to the following procedure. The tested adhesive composition was first mixed with water using a handheld drill mixer to obtain a wet adhesive composition. The mixing time was ca. 2 minutes and mixing speed was 600 rpm. The wet adhesive composition was then applied to a surface of the cementitious substrate using a suitable toothed trowel to form a wet adhesive layer having a coating weight of 0.15±0.05 kg/m². Sample strips having dimensions of 10×2 inch were cut from the sealing element, contacted with the wet adhesive layer, and pressed against it by using a standardized 500 g roller.

All test specimens were prepared by the “wet lay-in” method, where the sample strips were directly placed on the wet adhesive layers immediately after application, i.e., without airing of the wet adhesive layer. The sample strips were contacted with the wet adhesive layers such that the outer surface of the contact layer was directly contacted with the wet adhesive layer.

The cementitious substrates used in the examples of Table 2 had been let to cured for 24 hours before bonding of the sample strip to the surface of the substrate. The surface moisture content (wt.-% of water) of the cementitious substrate just before bonding of a sample strip was measured with a Tramex® CME4 screed moisture measuring instrument as average of three measurements.

The test specimens were stored for 2 days (Table 2) or 7, 14, or 21 days (Table 3) at normal room temperature before measuring of peel strengths. The peel force during peeling of the sample strips from the surface of the substrate at a peeling angle of 90° were determined using a peel jig apparatus. The peeling of the sample strip was continued at a constant cross beam speed of 100 mm/min until the strip was completely detached from the surface of the substrate. The representative peel resistance was calculated as peel force per unit width of the sample strip [N/50 mm] measured when half of the sample strip had been peeled off.

The values for “peel resistance” shown in Table 2 have been determined as an average of five measurements conducted with the same adhesive composition whereas the results in Table 3 have been obtained as an average of three measurements conducted with the same adhesive composition.

TABLE 2

| Compositions [pbw] | Ex-1 | Ex-2 | Ex-3 | Ex-4 | Ex-5 | Ex-6 |
|---|---|---|---|---|---|---|
| SP1 | 11.0 | 11.0 | 11.0 | 11.0 | 11.0 | 11.0 |
| CAC | 30.9 | 29.8 | | | 32.0 | |
| OPC | 28.9 | 28.8 | 66.9 | 67.0 | 27.7 | 63.9 |
| Additive 1 | 7.0 | 7.0 | | | 7.0 | |
| Additive 2 | 0.3 | 1.2 | | | 0.3 | |
| Additive 3 | | 0.1 | 0.1 | | 0.1 | 0.1 |
| Total dry adhesive | 78.0 | 78.0 | 78.0 | 78.0 | 78.0 | 75.0 |
| Water | 22.0 | 22.0 | 22.0 | 22.0 | 22.0 | 25.0 |
| Total wet adhesive | 100.0 | 100.0 | 100.0 | 100.0 | 100.0 | 100.0 |
| ^{a}Moisture content of substrate [wt.-% water] | 3.9 | 4.8 | 4.3 | 4.3 | 4.0 | 3.9 |
| ^{b}Peel strength [N/50 mm] | 158.6 | 175.8 | 172.5 | 155.6 | 167.3 | 161.9 |

^{a}after 24 hours of curing of substrate
^{b}after 2 days curing of test specimen

TABLE 3

| Adhesive | Curing time | Curing time of | Average peel |
|---|---|---|---|
| composition | of substrate | test specimen | strength |
| of Ex-4 | [days] | [days] | [N/50 mm] |
| Ex-4-1 | 1 | 7 | 130 |
| Ex-4-2 | 1 | 14 | 132 |
| Ex-4-3 | 1 | 21 | 154 |
| Ex-4-4 | 2 | 7 | 135 |
| Ex-4-5 | 2 | 14 | 141 |
| Ex-4-6 | 2 | 21 | 118 |
| Ex-4-7 | 7 | 7 | 133 |
| Ex-4-8 | 7 | 14 | 137 |
| Ex-4-9 | 7 | 21 | 135 |

1. A method for bonding a sealing element to a substrate, the method comprising steps of:
I) providing an adhesive composition and mixing the composition with water to obtain a wet adhesive composition,
II) applying the wet adhesive composition to a surface of the substrate or to a surface of the sealing element to form a wet adhesive layer,
III) joining the sealing element with the substrate such that the wet adhesive layer forms an interlayer between the sealing element and the substrate such that at least a portion of the opposing surfaces of the sealing element and the substrate are directly connected to each other via the interlayer, and
IV) letting the wet adhesive layer to harden to effect adhesive bonding between the sealing element and the substrate, wherein
the adhesive composition comprises:
a) 2.5-50 wt.-% of at least one synthetic organic polymer and
b) 25-95 wt.-% of at least one hydraulic binder, the proportions being based on the total weight of the adhesive composition.

2. The method according to claim 1, wherein the adhesive composition is a one-component adhesive composition.

3. The method according to claim 1, wherein the substrate is selected from the group consisting of concrete body, an insulation board, or a cover board.

4. The method according to claim 1, wherein the surface of the substrate is a primed or non-primed surface.

5. The method according to claim 1, wherein the substrate is a concrete body.

6. The method according to claim 1, wherein the substrate has a surface moisture content determined according to ASTM F2659 standard of at least 2 wt.-% of water.

7. The method according to claim 1, wherein the at least one synthetic organic polymer is in form of a re-dispersible polymer powder.

8. The method according to claim 1, wherein the at least one hydraulic binder is selected from the group consisting of Portland cement, calcium aluminate cement, and calcium sulfoaluminate cement.

9. The method according to claim 1, wherein the weight ratio of the amount of water to the amount of the at least one hydraulic binder in the wet adhesive composition obtained from step I) is in the range of 0.1:1 to 2:1.

10. The method according to claim 1, wherein the interlayer formed in step III) by joining of the sealing element with the substrate contains at least 75 wt.-% of the amount of water contained in the wet adhesive composition obtained from step I).

11. The method according to claim 1, wherein the sealing element is selected from the group consisting of a waterproofing membrane, roofing membrane, gas barrier membrane, volatile organic compound barrier membrane, vapor barrier membrane, vapor retarder membrane, façade membrane, and a geomembrane.

12. The method according to claim 1, wherein the sealing element comprises a contact layer and wherein in step III) the sealing element is joined with the substrate such that
the wet adhesive layer forms an interlayer between the contact layer and substrate.

13. The method according to claim 12, wherein the contact layer is selected from a layer of fiber material, a filled polymeric layer, a bitumen-based layer, and a layer of pressure sensitive adhesive.

14. The method according to claim 12, wherein the contact layer is a layer of fiber material.

15. The method according to claim 12, wherein the contact layer is a filled polymeric layer comprising:
20-90 wt.-% of at least one polymer,
5-75 wt.-% of at least one inorganic filler, all proportions being based on the total weight of the filled polymeric layer.

16. The method according to claim 15, wherein the at least one polymer comprises at least one ethylene vinyl acetate copolymer.

17. The method according to claim 1, wherein the sealing element comprises a waterproofing layer having upper and lower major surfaces and comprising at least one polymer.

18. A wet adhesive composition obtained by mixing an adhesive composition with water for bonding of a sealing element to a surface of a substrate, wherein the adhesive composition comprises:
a) 2.5-50 wt.-% of at least one synthetic organic polymer and
b) 25-95 wt.-% of at least one hydraulic binder, the proportions being based on the total weight of the adhesive composition.

19. The wet adhesive composition according to claim 18, wherein the substrate is a concrete body.

20. The wet adhesive composition according to claim 18, wherein the substrate has a surface moisture content determined according to ASTM F2659 standard of at least 2 wt.-% of water.
